(19) United States
(12) Patent Application Publication
(10) Pub. No.: US 2017/0084180 A1
(43) Pub. Date: Mar. 23, 2017

(54) STABLE PARTITION OF TRAJECTORIES SET INTO ASYMPTOTICALLY CONVERGED BEAMS

(71) Applicants: Olga Borisovna Bondaletova, Moscow (RU); Maria Olegovna Solntseva-Chaley, Moscow (RU)

(72) Inventors: BORIS Georgiyevich Kukharenko, Moscow (RU); Maria Olegovna SOLNTSEVA-CHALEY, Moscow (RU)

(21) Appl. No.: 15/258,736

(22) Filed: Sep. 7, 2016

(30) Foreign Application Priority Data
Sep. 18, 2015 (RU) 2015139739

(51) Int. Cl. G08G 5/00; G06F 17/30

(52) U.S. Cl. CPC G08G 5/0017; G08G 5/0073; G06F 17/30536

(57) ABSTRACT

A system and method for data tracking, processing, and analysis of multidimensional space trajectories of moving objects. The method is particularly applicable for moving objects having closely spaced final targets, such as aircraft landing at airport runways. The method may be used for air space sectorization. The method is provided for determining the number of asymptotically converged beams of the trajectories in 3D-space. Points of the trajectory sample are scattered into a set of independent points of the trajectories. Two-dimensional orthogonal projection of the set of points is considered and the most likelihood orthogonal linear regression of the points is defined. Such linear regression represents an asymptote tangential to a beam. Certain beam of trajectories is separated in reverse transition into original data space.

### PRIORITY STATEMENT

This application claims the benefit of Russian Patent Application No. 2015139739.

### FIELD OF INVENTION

The present invention generally relates to the field of data mining, data track mining and, specifically, to the processing and analysis of multidimensional space trajectories of moving objects with common targets and close final space coordinates, as, in particular, aircraft intent trajectories in airport runways.

### BACKGROUND OF THE INVENTION

Currently, due to increasing data volume, it is important to design methods and tools for rapid and automatic processing of large data sets. New approaches are required for analysis of large data sets (like unsupervised data mining or other machine learning technics), that can recognize hidden patterns of motion and identify moving objects with similar characteristics and/or the same final targets.

In many areas, particularly, in aviation, it is necessary to process huge sets of trajectory data for monitoring, control or other purposes. Aircraft trajectory is represented by four-dimensional description of the aircraft states with time, where state may include a position of aircraft center of mass and other characteristics of the motion, like velocity, attitude and weight. So, in general, the space trajectory is a multidimensional description of moving object path.

According to statistical data, the large number of avionics incidents takes place in extended airport area due to increased work load of air traffic management (ATM) systems. While air traffic is permanently increased, modernization and optimization of ATM systems are needed to maintain high level of safety.

Automation system TRACON (Terminal Radar Approach Control) [1,2] disclosed in U.S. Pat. No. 6,393,358 is used for simplifying of activity of traffic control services, ensuring air traffic control and reducing workload of air space within the extended airport area. The systems as described allow ensuring of air traffic control within air space and increase airspace capacity. TRACON is used for establishing a spacing reference geometry, predicting spatial locations of a plurality of aircraft at a predicted time of intersection of a path of a first of said plurality of aircraft with the spacing reference geometry, and determining spacing of each of the plurality of aircraft based on the predicted spatial locations.

Aircraft trajectories' analysis is essential for optimization of air traffic control operations, minimization of losses in air traffic efficiency, airspace corridor design, space sectorization, creation of unmanned aerial vehicles, etc. For example, US 20140019033 A1 describes a method of air traffic planning that includes defining an arrival network of nodes and legs, used for optimization of schedule of arrived aircrafts.

Data mining methods are widely used in investigations on work load optimization in extended airport area. The methods are, in particular, used for air space sectorization, i.e. space partitioning into the sectors or zones of different controllers' responsibility. Air space sectorization should be done taking into account regular flows of motion that are described by the samples of aircraft trajectories.

Up to date sectorization problem is solved in considering 2D-projection of the aircrafts' trajectories by its' clustering [3] or space partitioning into the regions like Voronoi-diagrams [4].

Development of the 3D-sectorization algorithm is at initial stage and associated with the problem of trajectory beams revealing (separation) in 3D-space. Trajectory beams are corresponding to the groups of 3D-trajectories with similar characteristics. For trajectory sample partitioning into the beams such methods as PCA [5], nonparametric approach based on Dynamic Bayesian Networks [6], spectral clustering [7] are used. The methods are based on reduction of analyzed data space dimensions.

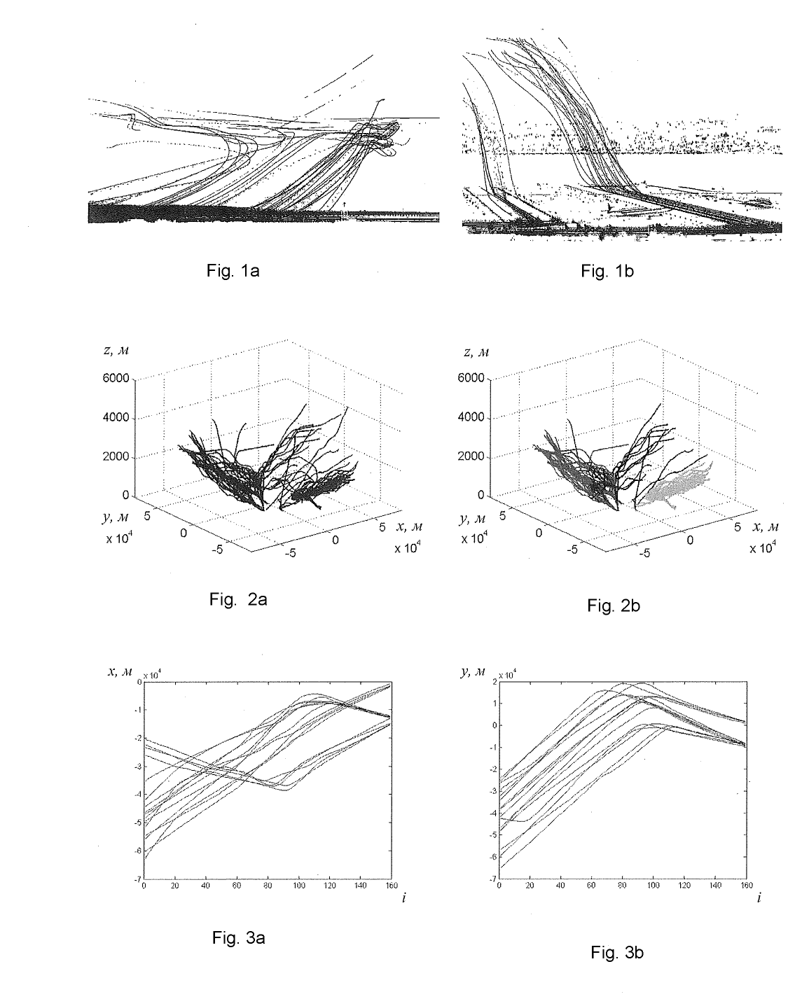

In analyzing the sets of multidimensional space movement trajectories, their special features like multiple intersections, curvature and torsion (see FIG. 1a) should be taken into account. So, it is desirable to use a similarity measure that would allow to distinguish the trajectories with similar shape even if they are mutually spaced. The similarity measure should reflect likeness (or distinction) of trajectory shapes in 3D-space.

If the objects move to common (defined, given) targets and their final coordinates are close, the object trajectories form converged beams of multidimensional space trajectories of motion, like in the case of intent trajectories of aircrafts landing on the same runway (See FIG. 1b). Generally, the trajectories in such beams may have multiple intersections. Beam convergence is defined by a threshold parameter. Threshold parameter for aircraft trajectories' beams does not exceed a runway width.

In the present invention a new approach [8] to analysis of multidimensional trajectories of moving objects with common targets and close in coordinates is proposed. The present invention permits to separate asymptotically converged beams of trajectories and is based on determination of geometric asymptote tangent to multidimensional trajectory beam in the lower dimension space. Then trajectory beam is separated in the result of reverse transition to the original data space. Such approach, while being applied to the analyses of real data (like radar data), allows getting stable results.

### DETAILED DESCRIPTION OF DRAWINGS

FIGS. 1a and 1b show trajectory beams formed by the trajectories of aircrafts landed at the San-Francisco Airport (SFO), runway 1L&1R. FIG. 1a demonstrates complexity of space geometry of analyzed data having specific curvature, torsion and multiple space intersections. Example of intent trajectory beams on a runway is shown in FIG. 1b.

FIG. 2a illustrates the analyzed sample, containing 116 intent trajectories of aircrafts landed at airports of San Francisco bay area 1 Jan. 2005 year (the data is freely available at https://c3.nasa.govidashlink/resources/132/). Analyzed data were recorded by TRACON radar system [1,2]. Reference point coincides with the radar location, time interval between registration points is about 5 sec. Each trajectory contains 160 points.

FIG. 2b shows the analyzed sample of trajectories (see FIG. 2a) preliminarily divided into 5 subsamples according to the similarity of their shape using the polynomial regression method [9,10]. Magenta subsample contains 16 trajectories, red, black, green and blue subsamples 38, 37, 13, 3 trajectories, correspondingly.

FIGS. 3a and 3b represent the projection of magenta sub-sampled trajectories onto the x and y axis. It should be noted that the trajectories of subsample under consideration have multiple intersections. Existence of practically linear elements at a distance from its' focus is another particularity of such the trajectories.

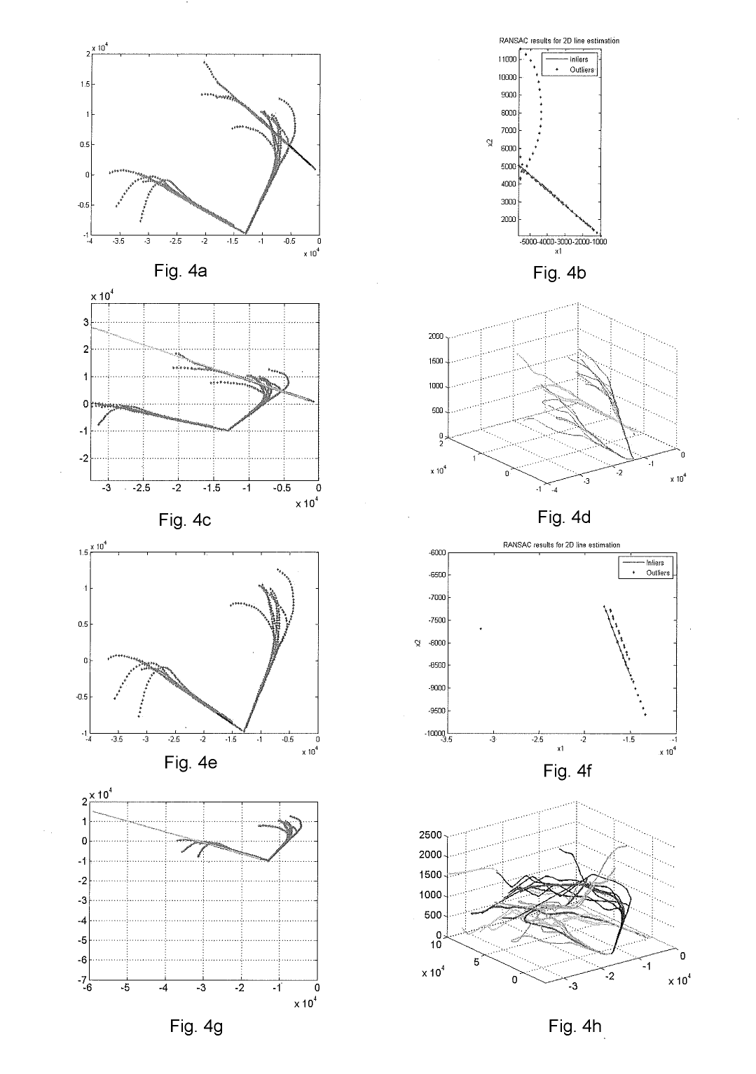

FIGS. 4a-4h illustrates the invention steps, at that the analyzed magenta subsample is divided into asymptotically converged beams.
FIG. 4a shows two-dimensional projection of scattered data (aligned with time) of the analyzed subsample. As all trajectories in the subsample have the same time direction, the scattered data of reduced trajectories (with the points' quotum 0.4, starting from the focuses of the beams) are analyzed.
FIG. 4b illustrates the result of data's linear regression obtained with the help of RANSAC [11] algorithm
FIG. 4c represents defined asymptote of the first beam (blue line). It should be noted that in this case the results of the orthogonal linear regression of scattered and full trajectories coincide.
FIG. 4d shows the first (blue) beam consisting of the trajectories that are proximal to the blue asymptote (see FIG. 4c) according to cosine measure. Then the trajectories of the separated beam are removed from the analyzed subsample.
FIGS. 4e-4h show removing trajectories of the first separated beam from the subsample, the next asymptote and corresponding trajectory beam are defined similarly in the rest of the subsample. Further, the second (green) beam is separated which trajectories are proximal to green asymptote according to cosine measure.

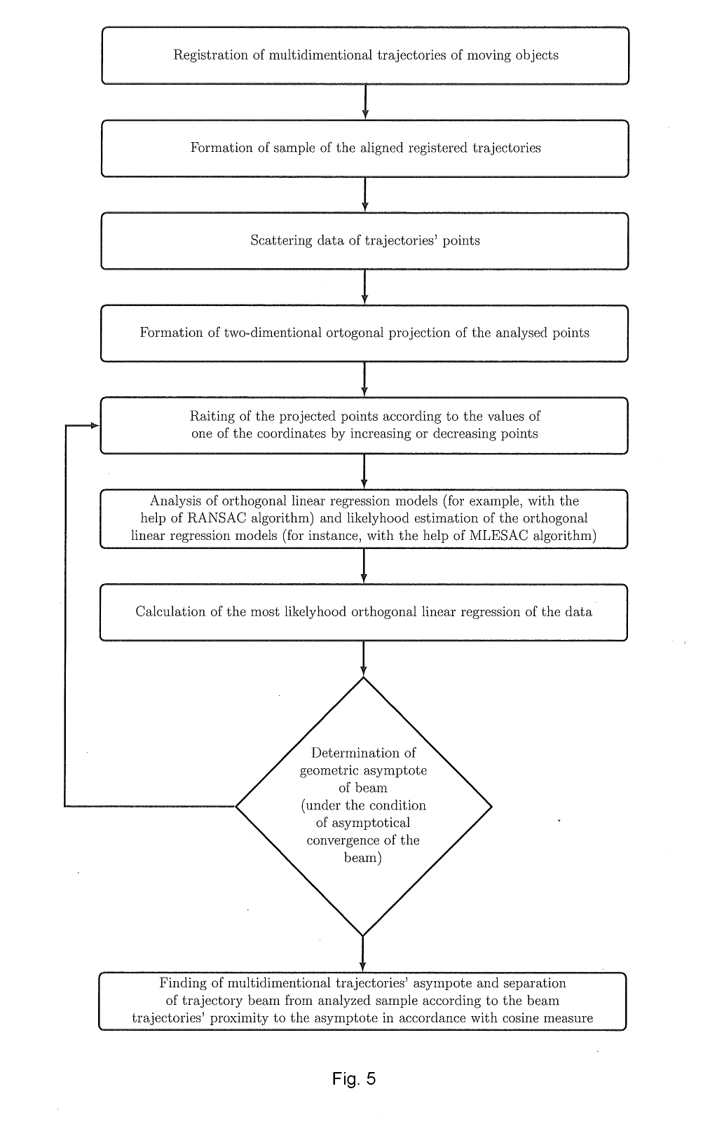

FIG. 4h demonstrates three trajectory beams (blue, green and dark blue) separated in the sample under consideration in the result of consecutive iterations of the invention. Central trajectory of each beam is highlighted in red.
FIG. 5 shows the invention process diagram.

### DETAILED DESCRIPTION OF THE INVENTION

### Assessment of Beam's Asymptote

Trajectory beam Nₖ, k=1̅,̅K̅₀̅ (K₀ is empirical parameter) is considered as asymptotically converged with a threshold parameter ε, if for all vectors {x[i]∈R^{3×L}, i∈Nₖ} in the beam Nₖ, k=1̅,̅K̅₀̅, a condition of asymptotic convergence of the beam is fulfilled

∀(i,j)∈Nₖ, ∥x[Lᵢ;i]∥x[Lⱼ;j]∥₂<ε (1)

where (∀i∈Nₖ, x[Lᵢ;i] are coordinates of final trajectory points on a runway. Parameters Lᵢ, i∈Nₖ are subject to determination, ∥. . . ∥₂ is Euclidean distance metric in three-dimensional coordinate space R³, ε is a cutoff parameter with value of no more than runway width. In considering the claimed approach to determination of the number of asymptotically converged beams, it should be taken into account that the trajectories in the beams have some typical form (profile) and specific geometric asymptote in the region of convergence (1). Geometric asymptote in converged beam of multidimensional aircraft intent trajectories is a line in R³ that meets the requirement (1). Trajectories in asymptotically converged beam have tangent line in area around the final points ∀i∈Nₖ, x[Lᵢ;i]. So, asymptotically converged trajectory beams can be identified by determination of their tangential geometric asymptotes in the points of their focuses.

Because discrete points of beam trajectories are tightly located around its' asymptote, to determine the number of asymptotically converged beams a sample of trajectory vectors {x[i]∈R^{3×L}, i=1̅,̅ N̅} is scattered into set of the trajectories' points

{x[i]∈R^{3×L},i=1̅,̅N̅} [symbol] {(x[j,i], y[j,i], z[j,i])∈R³, j=1̅,̅L̅, i=1̅,̅N̅}. (2)

Set of the points (2) has to be sorted according to the values of one of the coordinates (in ascending or descending order). At that, other coordinates of points, representing converged trajectory beam of certain profile, are also ordered. Then, for the scattered three-dimensional data {zᵢ=(xᵢ, yᵢ, zᵢ), i=1̅,̅L̅·̅N̅} (2); orthogonal linear regression models

M(θ)={(x,y,z)∈R³|(a₁x+b₁y+c₁z=d₁) [symbol] (a₂x+b₂y+c₂z=d₂)} (3)

are analyzed by RANSAC (Random Sample and Consensus) algorithm Here symbol [symbol] is conjunction, θ={a₁,b₁,c₁,d₁, a₂,b₂,c₂,d₂} is vector of the parameters of the models (3), that is determined under given cutoff of Euclidian distance ρ_{⊥}(z,M(θ)) calculated by orthogonal projection of point z=(x, y, z) from the set (2) onto a line M (θ). By such a way the model (3) is symmetrical relatively to the coordinates x, y, z . Any pair of the points from (2) is sufficiently to put forward a hypothesis about the model of orthogonal linear regression (3). Final model (3) is proved by the greatest relative quantity (percent) of scattered data {zᵢ=(xᵢ, yᵢ, zᵢ), i=1̅,̅L̅·̅N̅} (2). Algorithm MLESAC (Maximum Likelihood Estimation Sample Consensus) [12], that is probabilistic modification of RANSAC [11] algorithm, may be used for these purposes. The algorithm estimates likelihood of the model (3), in representing distance distribution of scattered data {zᵢ=(xᵢ, yᵢ, zᵢ), i=1̅,̅ L̅·̅N̅} from the model M(θ) (3) as a mixture of data distributions some of which support the model (3) (inliers), while the rest ones reject it (outliers). Considering the scattered data Z (2) as independent, we obtain a relation for logarithm of likelihood as following

$$L ( {ρ}_{⊥} ( Z , M ( θ ) ) \text{\textbar} θ ) = {\sum }_{i = 1}^{L \cdot N} log ( γ p ( {ρ}_{⊥} ( {z}_{i} , M ( θ ) ) \text{\textbar} {z}_{i} is inlier ) + ( 1 - γ ) p ( {ρ}_{⊥} ( {z}_{i} , M ( θ ) ) \text{\textbar} {z}_{i} is outlier ) ) , \qquad ( 4 )$$

where γ is mixing parameter. Distribution of the distances to the data, supporting the model (3), is represented by Gaussian distribution

$$p ( {ρ}_{⊥} ( {z}_{i} , M ( θ ) ) \text{\textbar} {z}_{i} is inlier ) ∝ exp ( - \frac{{( {ρ}_{⊥} ( {z}_{i} , M ( θ ) ) )}^{2}}{2 {σ}^{2}} ) , \qquad ( 5 )$$

where σ is standard deviation. Distribution of distances to the data, rejecting the model (3), is described by uniform distribution

$$p ( {ρ}_{⊥} ( {z}_{i} , M ( θ ) ) \text{\textbar} {z}_{i} is outlier ) = \{ \begin{matrix}{( 2 {ρ}_{max} )}^{- 1} , & {ρ}_{⊥} ( ( {z}_{i} , M ( θ ) ) < {ρ}_{max} \\ 0 , & {ρ}_{⊥} ( ( {z}_{i} , M ( θ ) ) \geq {ρ}_{max}\end{matrix} , \qquad ( 6 )$$

where ρₘₐₓ is maximal distance to data (it is defined by the context). Likelihood logarithm (4) minimization allows to evaluate vector of the parameters θ and mixing parameter γ. Estimation of the parameters is traditionally done using EM-algorithm [13].

It is obvious for the specialist, that apart from the algorithms considering at the present work in determining of the geometric asymptote M(θ)[k], k=1̅,̅K̅ (3) of one of the beams under condition (1), other methods can be used.

The most likely linear regression of the scattered data of trajectory sample defines geometric asymptote M(θ)[k], k=1̅,̅ K̅ (3) of one of samples' beams under (1). The geometric asymptote received in such a manner meets the requirement

∀k=1̅,̅K̅, ∀i∈Nₖ, ∥M(θ)[Lₖ,k]−x[Lᵢ;i]∥₂<ε.

### Separation of Trajectory Beam

Beams of the trajectories tangential to the geometric asymptotes are defined as the result of minimization of a cost function

$$J = {arg min}_{\{ M ( θ ) [ k ] , k = \overline{1 , K} \}} {\sum }_{i = 1}^{N} {\sum }_{k = 1}^{K} r [ i ; k ] {ρ}_{cosin}^{2} ( x [ i ] , M ( θ ) [ k ] ) ,$$

where {r[i;k]∈{0,1}, k=1̅,̅K̅}, i=1̅,̅N̅ is set of binary indicator variables (e.g. if vector x[i] was attributed to the beam k , then r[i;k]=1 and r[i;k]=0, otherwise). Distance between each geometric asymptote and the sample's trajectories is calculated according to cosine measure

ρ cosin(x,M(θ)[k])=(x·M(θ)[k])/(\sqrt{(x·x)}{square root over ((M(θ)[k]·M(θ)[k]))}).

After elimination of the points, representing the trajectories of separated beam, from the scattered data (2), the procedure of geometrical asymptote detection is repeated and the next trajectory beam is separated. In this case, remained scattered data (2) are sorted with respect to another space coordinate (different from the previous one), as the model determination should be symmetric relatively to the coordinates x, y, z. Possible dependence of result (3) from the coordinate directions is obviated by changing direction of data ordering in (2) from ascending to descending order or vice versa. Analysis of trajectory sample is completed, when all beams in the sample are separated (see FIG. 4h).

In general, the approach described in the claimed invention consists of two stages. Sufficient reduction of data dimensions at the first stage simplifies the revealing of data specific features. In considering 2D-projection of scattered points of 3D trajectories, the most likelihood orthogonal linear regression of the scattered data which corresponds to geometrical asymptote of one of the beams in analyzed sample of the trajectories is defined. At the second stage of the approach, after reverse transferring into the original dimensional space, a certain beam is separated from the analyzed trajectory sample in accordance with proximity (by cosine measure) to defined asymptote. Thus, due to such approach no information about original data is lost. Detailed scheme of the claimed invention is shown in FIG. 5.

### REFERENCES

1. Erzberger H., Davis T. J., Green S. Design of center-TRACON automation system//In AGARD, Machine Intelligence in Air Traffic Management—1993.
2. Williams D. H., Green S. M. Flight evaluation of Center-TRACON Automation System trajectory prediction process.—National Aeronautics and Space Administration, Langley Research Center, 1998.
3. Mcfadyen A., O'Flynn M., Martin T. and Campbell D., Aircraft trajectory clustering techniques using circular statistics//2016 IEEE Aerospace Conference, Big Sky, Mont.—2016, pp. 1-10.
4. Sergeeva M., Delahaye D., Mancel C., Zerrouki L., Schede N. 3D Sectors Design by Genetic Algorithm Towards Automated Sectorisation. 5th SESAR Innovation days, December 2015, Bologna, Italy.
5. Gariel M., Srivastava A., Feron E. Trajectory clustering and an application to airspace monitoring//IEEE Transactions on Intelligent Transportation Systems.—2011. - Vol. 12, no. 4. Pp. 1511-1524.
6. Bastani V., Marcenaro L. and Regazzoni C. Unsupervised trajectory pattern classification using hierarchical Dirichlet Process Mixture hidden Markov model//2014 IEEE International Workshop on Machine Learning for Signal Processing (MLSP), Reims, 2014, pp. 1-6.
7. Enriquez M., Kurcz C. A simple and robust flow detection algorithm based on spectral clustering//International Conference on Research in Air Transportation (ICRAT)/Federal Aviation Administration (FAA) and EUROCONTROL. Berkeley, Calif., USA: 2012. May 22-25.
8. Kukharenko B., Solntseva-Chalei M. Centroid Modeling for multidimensional trajectory pencils/Informacionnye tehnologii, 2016, V. 22, N.2, P.83-89.
9. Gaffney S., Smyth P. Joint probabilistic curve clustering and alignment/Saul L., Weiss Y., Bottou L., eds. Proceedings of Neural Information Processing Systems (NIPS 2004). Dec. 13-18, 2004, Vancouver, British Columbia, Canada. Advances in Neural Information Processing Systems. V.17. Cambridge, Mass.: MIT Press. 2005. P.473-480.
10. Kukharenko B, Solntseva M. Klasterizacia upravlyaemyh objektov na osnove shodstva ih mnogomernyh trajektoryi/Informacionnye tehnologii, 2014, N.5, P.3-7.
11. Fischler M. A., Bolles R. C. Random sample consensus: a paradigm for model fitting with applications to image analysis and automated cartography//Communications of the ACM.—1981.—T. 24.—Ns. 6.—C. 381-395.
12. Torr P. H. S., Zisserman A. MLESAC: A new robust estimator with application to estimating image geometry//Journal of Computer Vision and Image Understanding. 2000. V.78, No.1. P. 138-156.
13. Dempster, A. P., Laird, N. M., & Rubin, D. B. (1977). Maximum likelihood from incomplete data via the EM algorithm//Journal of the royal statistical society. Series B (methodological). P. 1-38.

1. A method for number determination of asymptotically converged beams of multidimensional space trajectories of movement of objects in given direction and with given cutoff parameter, that includes registration of mentioned multidimensional space trajectories of motion; necessity rating of time relative alignment of registered trajectories and the alignment, when required; sample formation of registered trajectories; representation of trajectory sample as a set of independent points from every trajectory; formation of two-dimensional orthogonal projection of the point sample and, at least, a single-fold ordering of the projected points in ascending or descending values of one of the coordinates; analysis of the most likely model of orthogonal linear regression for ordered projected points with determination of geometric asymptote if given cutoff parameter, and separation of trajectory beam from the formed trajectory sample according to proximity measure between the trajectories and the determined geometric asymptote; at that, the similarity measure is determined by cosine measure under given cutoff parameter and it is calculated in a range of the values from 0 to +1, wherein, in according to the results of each previous ordering, the next ordering and analysis are carried out by removing the trajectories of the separated beam from the formed trajectory sample.

2. The method of claim 1, wherein the separated beam contains the greatest number of the trajectories.

3. The method of claim 1, wherein multidimensional space trajectories of objects' movement are intent trajectories of aircrafts and/or flying vehicle.

4. The method of claim 3, wherein cutoff parameter is no more than runway width.
